(19) United States
(12) Patent Application Publication
(10) Pub. No.: US 2005/0281612 A1
(43) Pub. Date: Dec. 22, 2005

(54) Method for assembling countertop and joint used therein

(76) Inventor: David Boone, Chesapeake, VA (US)

Correspondence Address: BIRCH STEWART KOLASCH & BIRCH, PO BOX 747, FALLS CHURCH, VA, 22040-0747, US

(21) Appl. No.: 10/867,687

(22) Filed: Jun. 16, 2004

(51) Int. Cl. B25G 3/34

(52) U.S. Cl. 403/270

(57) ABSTRACT

A method of assembling a solid surface countertop and a joint used in such assembly. Rather than building up a corner area of a countertop and cutting a radiused corner, pieces are preformed in the shop having interlocking pieces to provide additional strength and ease of assembly. The pieces interlock using a similar shaped joint for the edge pieces and the corner block.

### BACKGROUND OF THE INVENTION

1. Field of the Invention

The present invention relates generally to the assembly of a countertop and more particularly to the assembly of a solid surface countertop using a shaped joint for extra strength and ease of manufacture.

2. Discussion of the Background

A number of different types of materials have been used over the years for horizontal surfaces used in kitchens and other places. While wood and stone have been used for a very long time, more modern materials are preferred to provide surfaces which are less prone to staining, easier to clean and more attractive. Porcelain surfaces were utilized for a number of years but have given way to laminates such as FORMICA which are less expensive.

More recently, solid surface countertops have achieved great popularity for kitchen countertops and other horizontal surfaces. This material is produced by several different companies under different trademarks with one of these being known as CORIAN made by Dupont. This material has a number of advantages in that it has a very hard and smooth surface and at the same time is very attractive. Of particular importance is the fact that the material may be cut with a router or similar tool so that it is not necessary to prefabricate the surface shape during the manufacturing process of the solid surface material.

However, there are some difficulties in using this material. The material itself is somewhat expensive and accordingly it is very important not to waste material, in order to keep the price of the countertop competitive. Solid surface sheets are normally supplied in a thickness of ½″. The normal thickness of solid surface countertops at exposed edges is 1½″. Therefore a build-up at the exposed edge is added to achieve the desired thickness. Also, the material is easily cracked if sharp corners are formed. Accordingly, both inner and outer corners on the countertop should have a radius rather than a sharp corner. While the countertop material may be worked in the field using standard tools, it still requires a substantial amount of time of an experienced workman in order for the countertop to be properly adhered and shaped so as to avoid weak areas susceptible to cracking. The cost of labor of an experienced workman in assembling the countertop and shaping the corners constitutes a major part of the cost of the entire countertop. Accordingly, it is important that the time of assembly be decreased as much as possible to avoid any unnecessary costs.

### SUMMARY OF THE INVENTION

Accordingly, the present invention provides a method of assembling a countertop.

The present invention further provides a method of assembling a solid surface countertop using shaped components and joints.

The present invention further provides a shaped joint for use in assembling a solid surface countertop.

The present invention further provide preshaped parts for assembling a countertop.

The present invention still further provides a method of assembling a solid surface countertop utilizing shaped joints which are precut.

Briefly, the invention achieves this by providing parts which are shaped and wherein the joints have matching contours and an interlocking joint to provide a more glue-able surface and additional strength of the assembly components.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing, wherein

FIG. 1 is a plan view of a countertop;

FIG. 2 is a perspective view of the underside of a prior art technique for forming an inner corner of built up layers;

FIG. 3 is a perspective view of a prior art technique forming an outer corner;

FIG. 4 is a plan view of the underside of the countertop formed according to the present invention; and

FIG. 5 is an exploded view of the parts forming an outer corner of the countertop shown in FIG. 4.

### DESCRIPTION OF THE PREFERRED EMBODIMENTS

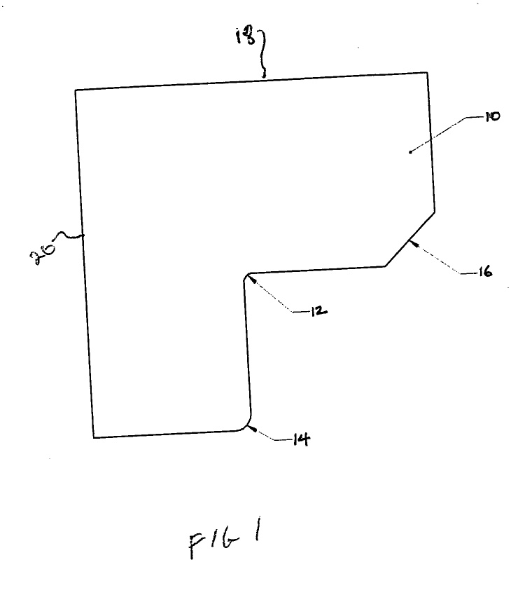

Referring now to the drawings wherein like reference numerals designate identical or corresponding parts throughout the several views and more particularly to FIG. 1 thereof, wherein the countertop 10 is shown as having an L shape in plan view. Of course, other shapes are possible. The countertop has one inside corner 12, one outside radiused corner 14 and one outside angled corner 16. Edges 18 and 20 are placed against back walls.

In the assembly of the countertop, it is preferred that the final product has the appearance of substantial thickness and in particular has a thick edge around the visible periphery of the countertop. This dimension can be for example an inch and a half or other thickness. However, it is not necessary for the entire countertop to be this thick and in fact the main surface of the countertop can be perhaps one half inch thick. While it would be possible to enlarge the entire countertop to this full thickness, this is unnecessary and is wasteful of materials which are quite expensive. Accordingly, the countertop is normally formed with a thinner layer which extends across the entire surface and the edge is formed by adding a vertical section to give the appearance of additional thickness. This edge can be formed either by vertically aligning a narrow piece along the edge, or by building up two or more layers along the edge. While this is done in common practice, it is tedious work since the adhesive must be carefully applied in order for the final product to have full strength and in order for the manufacturer of the material to guarantee the final product. Thus, considerable time is utilized in forming the edge of the countertop.

Even more difficult is the formation of corners, both inside and outside. While it is relatively easy to cut simple corners in the material, square corners give rise to cracks due to stress concentrations in the material. Accordingly, it is required to use a radiused corner, such as is shown in FIG. 1 at 12 and 14. It is also possible to utilize an angled corner such as shown in 16.

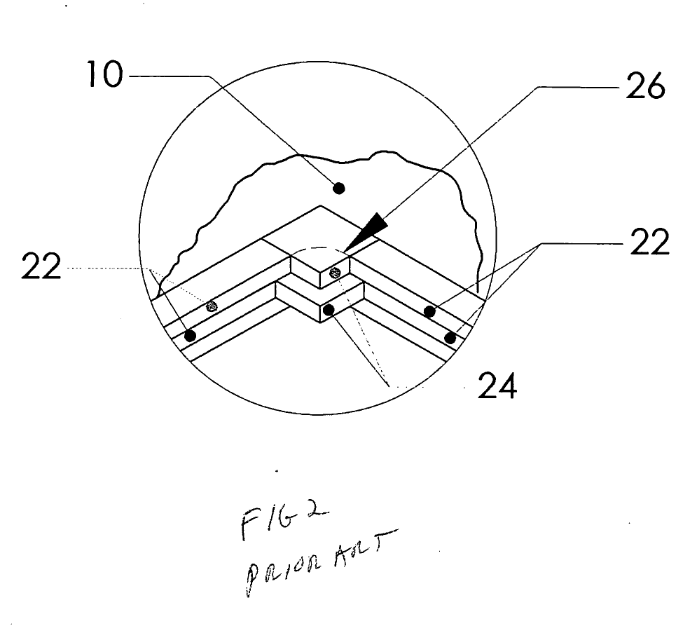

In the prior art, a common method of forming such a radiused corner is shown in FIG. 2. Layers of material are added horizontally along the edge of the main sheet of the countertop 10. In addition, blocks of material 24 are similarly added in the corners. Once all of the layers are properly adhered in place, a router or other similar cutting tool is used to remove the excess part of the corner block to form a radiused corner 26. In order for the corner to have sufficient strength, it is necessary that the blocks be somewhat large. This helps to avoid stress cracks and is also necessary for strength during the cutting operation. When the required radius 26 is cut, the workman normally utilizes a template or other guide, but otherwise basically performs the operation by hand. As a result, some imperfections will always be present and it requires further processing by sanding in order to make the radiused corner completely smooth. This process requires considerable time on the part of a skilled workman.

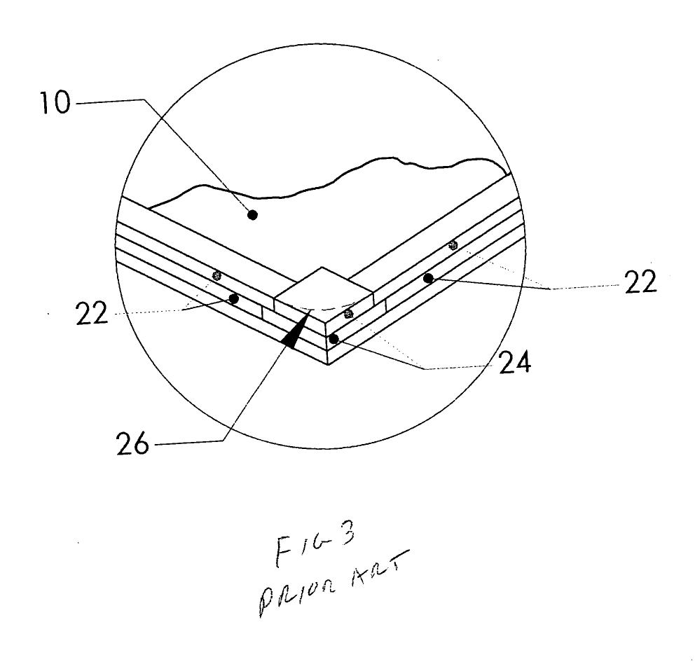

FIG. 3 shows a similar arrangement for an outside corner. Layers 22 are again placed along the edges and blocks 24 are placed in the corners. A required radius 26 is then cut using the workman's skill and possibly a template.

Whether cutting an inside corner or outside corner, there is considerable loss of material in the process. Further, even under the best of circumstances, additional processing in the form of sanding is necessary since the cut cannot be perfect when done by hand. Also, it is necessary that the block be oversized in order to provide enough strength for the processing and for eventual strength to avoid cracks.

While it is generally known that numerically controlled cutting machines can cut such material in a shop, the technique of pre-cutting shaped corners and matching interlocking shaped build-up components is not common practice.

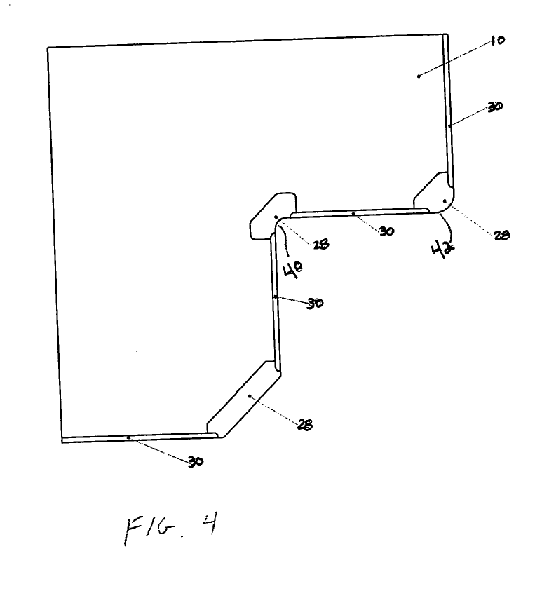

Applicants have avoided this problem by discovering that it is possible to precut parts in the shop and assemble them with interlocking corners and edges while increasing the desirable strength and avoiding the other difficulties presented in the prior art. As shown in FIG. 4, the countertop 10 includes edge pieces 30 to build up the visible edge of the countertop and also includes corner arrangements 28. The edge pieces 30 have a shaped edge where it abuts the corner piece so as to provide a stronger joint and assist assembly, thus avoiding the necessity for additional wasted material. Also, by forming these various parts in the shop, a better layout of the parts is achieved to avoid additional wastage. In addition, labor is significantly reduced. This is because the parts can be cut out by a numerically controlled cutter and laid out on a sheet of material using a computer aided arrangement, as is known in the art, in order to have less wastage when forming the parts. While normally the process of programming these parts would be prohibitively expensive, since the programmed cuts for the individual parts would have to be separately set up for each job. Applicants have utilized a parametric software arrangement so that the shape of the parts can be designed just once, so that for each subsequent job, the shape will remain the same while the sizes are adjusted appropriately so that reprogramming of the shape is not necessary. Thus, the set up time for forming the parts is also reduced.

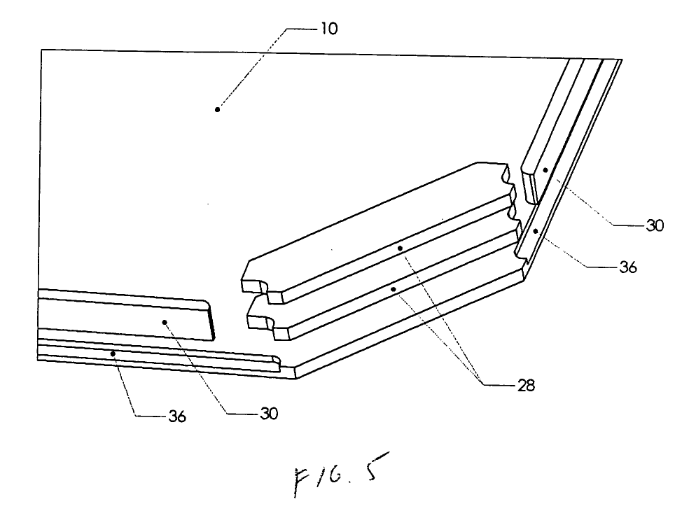

FIG. 5 shows an exploded view of the corner arrangement 28. The corner block is formed with two layers having the same shape. These two layers are adhered to the counter surface so that the outer edge is aligned with the outer edge of the counter. These layers are appropriately glued into place according to standard procedures. Edge pieces 30 are similarly glued into a rabbet formed along the edges of the countertop. The edges pieces are adhered to the countertop in the same standard fashion.

The end of the edge pieces 30 have a curved shape which match the curved shape of the layers 28 which form the corner block. By having these shapes identical, it is possible to adhere the edge pieces to the corner blocks so that they interlock and form a strong integral unit. By utilizing an interlocking shape which has more surface area for adhesive, additional strength results. Since all of the parts are cut in the shop using numerically controlled machines, the cuts are identical and less wastage occurs. Also, because the parts are laid out by computer, less wastage occurs in the layout process. While block 28 has been described in terms of the angled corner, other shapes can be formed for the inner and outer radiused corners 40 and 42.

The interlocking shape described above, does not have to be the specific curve as shown in FIGS. 4 and 5, but may be any shape which helps to interlock the edge piece with the corner block. However, such shapes should not be subject to stress buildup which can cause cracking of the material. Also, the exact same shape should be applied to both the edge pieces and the block pieces.

Furthermore, the countertop has been described as a solid surface material such as Dupont CORIAN. However, any type of similar material can be utilized, not only other brands of the same material, but also other related materials which can be shaped and properly adhered in order to buildup corners. Also, while a rabbeted edge has been shown in order to hold the edge pieces, such an edge is not strictly necessary and may be eliminated if sufficient strength is formed in the joint otherwise.

By utilizing the invention described above, less time is required for the workman. Furthermore, exact cuts can be made using numerically controlled cutting machines in the shop so that less sanding is required and better fits are obtained. Furthermore, less material is wasted both in the cutting operation and in the layout of the parts. Further, by utilizing parametric software, the shape may be defined once and the dimensions of new jobs may be simply inserted to obtain similarly shaped pieces but having different sizes.

Numerous additional modifications and variations of the present invention are possible in light of the above teachings. It is therefore to be understood that within the scope of appended claims, the invention may be practiced otherwise and as specifically described herein.

1. A method for assembling a horizontal work surface comprising:
a top piece in a shape of a desired work surface;
attaching edge pieces along visible edges of said top piece;
attaching corner pieces where edges of said top piece meet, said corner pieces being precut, said corner pieces and said edge pieces having an interlocking shape which mate to form a joint therebetween;
assembling said top piece, said edge pieces and said corner pieces to form said work surface.

2. The method according to claim 1, wherein the work surface is a countertop.

3. The method according to claim 1, wherein the top piece is a solid surface material.

4. The method according to claim 1, wherein said corner piece includes a plurality of layers.

5. The method according to claim 1, wherein said edge pieces and corner pieces are attached to said top piece using adhesive.

6. The method according to claim 1, wherein said interlocking joint is formed between interlocking surfaces on said edge piece and said corner piece, said interlocking surface being in the shape of a rounded corner and an adjacent elongated side.

7. An interlocking joint for a countertop assembly, comprising:
a first piece having a first interlocking surface;
a second piece having a corresponding second interlocking surface wherein said first piece and second piece are bonded together along said interlocking surfaces to form said interlocking joint.

8. The interlocking joint according to claim 7, wherein said first piece and said second piece are parts of a solid surface countertop.

9. The interlocking joint according to claim 7, wherein said first surface has a shape of a rounded corner with an elongated side.

10. The interlocking joint according to claim 7, wherein said joint is used in assembling a countertop.
